(19) United States
(12) Patent Application Publication
(10) Pub. No.: US 2006/0198973 A1
(43) Pub. Date: Sep. 7, 2006

(54) Packaging with cycloolefin food/beverage contact layer

(76) Inventor: Randy D. Jester, Greer, SC (US)

Correspondence Address: FERRELLS, PLLC, P. O. BOX 312, CLIFTON, VA, 20124-1706, US

(21) Appl. No.: 11/071,379

(22) Filed: Mar. 3, 2005

(51) Int. Cl. B32B 27/08

(52) U.S. Cl. 428/35.7

(57) ABSTRACT

A method of food packaging employs a flavor-preserving food contact layer of cycloolefin copolymer characterized by a total extractable concentration of less than about 30 ng per cm² of surface area when incubated in a 40 ml solution of 10% ethanol in distilled water for 24 hours at 60° C. with constant agitation. The food contact layer preferably exhibits a flavor scalping value lower than polyethylene.

### TECHNICAL FIELD

The present invention relates generally to multilayer packaging for foods or beverages. Packaging of the present invention utilizes an interior cycloolefin layer which has low extractables for contact with a food or beverage product, preventing the food or beverage from acquiring an “off-taste” and preserving its original flavor.

### BACKGROUND

Polymeric containers have long been used to package and contain consumable goods like foods and beverages. In particular, polyethylene is widely used in packaging consumable goods, sometimes referred to hereinafter as “consumables.” Polyethylene, however, is known to exhibit an undesirable propensity for imparting an “off-flavor” to the consumable it is in contact with because some consumables will leach extractable compounds from the polyethylene. See Aaron L. Brody, Flavor Interacts with Packaging, Prepared Foods (September 1989). It is believed that extractable compounds in a polymer generally originate from processes used to produce the polymer and also from additives that are mixed with the polymer. It is also possible that extrusion processes may produce certain extractable compounds. A particular source of off-flavor comes from the presence of extractable oligomers in polyolefins, which can impart a “plastic” taste to the consumable. The “off-taste” is especially noticeable in consumables without significant flavor, such as water. Potato chips are also especially vulnerable to exhibiting an off-flavor due to oligomers. In addition to creating an undesirable flavor and/or aroma, there are also concerns about the toxicity and carcinogenity of the extractable compounds. Accordingly, in order to maintain the flavor of the consumable in the packaging, it is desirable to reduce the transport of extractables, particularly oligomer extractables to the consumable product.

An additional concern with polymeric packaging is that the polymer can absorb or scalp flavor/aroma compounds from the consumable. This is problematic because it can allow the aroma of the consumable to leave the container, potentially creating an unpleasant effluvium in the surrounding environment (e.g. a refrigerator) or imparting unwanted flavors to other food products that are in close proximity. This problem is especially evident in thin walled containers such as bags. More importantly, a plastic which scalps flavor compounds will negatively affect the flavor of the consumable, causing it to lose its original flavor and perhaps take on a stale taste. Thus, there exists a need to provide a packaging film that reduces the amount of extractables that are imparted to consumable goods and also reduces the scalping of flavor and/or aroma compounds from the consumable.

Films employing a cycloolefin copolymer (“COC” or “COCs”) are well known in the art, and have been used to package consumables. For example, U.S. Pat. No. 6,607,423 to Hausmann includes a film with a sealant layer in contact with food and calls for a blend of a polar derivative of an ethylene based polymer and a cycloolefin polymer. The cycloolefin is usually present in an amount from 0.1-50 wt. % of the blend. The blend is selected for its properties of stiffness, perforation resistance, heat seal strength and hot tack strength. U.S. Pat. No. 5,912,070 to Miharu et al. discloses a film having at least three layers, one of which incorporates a cycloolefin polymer having a glass transition temperature in the range of 60-120° C. The cycloolefin layer may contain other resins in blends in amounts from 0.5-40%. Miharu discloses a configuration where the cycloolefin layer may be the inner layer of laminated film, but teaches that another layer is preferred. The films are reportedly suitable for packaging food and drugs because they can be torn easily by hand and have a good moisture permeation properties.

Further films employing cycloolfin copolymers have been proposed as noted below.

U.S. Pat. No. 6,680,094 entitled to Kikuchi et al. discloses a film with an oxygen absorbing layer and a barrier resin layer. The barrier resin layer may include cycloolefin copolymers, particularly a copolymer of ethylene and a cyclic olefin.

U.S. Pat. No. 6,713,165 to Karsten discloses a film structure having a plastic layer in contact with biological and medicinal tissues. The contacting layer is chosen for, among other things, sterilizability, weldability, impact strength, biocompatibility and extractables content (col. 1, lines 8-17). The contacting layer comprises at least 50 wt. % of a polyolefin of controllable crystallinity, which is described as a polyolefin comprising at least 90% of ethylene, propene, or butene which has a softening temperature of less than 121° C. The contacting layer may also optionally comprise a litany of various polymers, including a cycloolefin copolymer (col. 3, lines 45-67, col. 4 lines 1-16).

U.S. Pat. No. 6,544,610 to Minami et al. disclose packaging laminates having a layer comprised of a cycloolefin resin which is made of at least 30 wt. % of monomers with an alicyclic structure, and at least 10 wt. % of monomers having an alicyclic structure other than a norbornene structure (col. 2, lines 10-21). This cycloolefin resin layer is preferably the inner layer and is part of a laminate which may contain polyethylene. The laminates are reported to have reduced solubility, high chemical resistance, and high mechanical strength making them suitable for transporting industrial chemicals, medicines, food, etc.

Despite advancements in packaging films there still exists a need for a film which maintains the flavor of consumable goods. Accordingly, it is an object of the present invention is to provide films and containers that have a food/beverage contact layer which exhibits low extractable leaching and/or low flavor scalping. It has been discovered in accordance with the present invention that a film containing a polyethylene or polypropylene layer exhibits substantially improved maintenance of a consumable's flavor when a cycloolefin polymer layer is interposed between a polyethylene or polypropylene film and the food product, such that the cycloolefin layer is in contact with the consumable.

### SUMMARY OF INVENTION

There is provided in accordance with the present invention a method for packaging consumable products whereby a container is prepared with an interior wall bearing a food contact layer. The food contact layer has a thickness of about 0.5 to 50 microns and a consumable product is disposed in the container. The food contact layer is at least 75 wt. % cycloolefin copolymer and has an extractable concentration of less than 30 ng per cm² of surface area when incubated in a 40 ml solution of 10% ethanol in distilled water for 24 hours at 60° C. with constant agitation. Typically, the food contact layer is adhered to either a polyethylene or polypropylene layer.

The cycloolefin copolymers used in the inventive method usually incorporate a polycyclic structure or a cyclopropene group. In some embodiments the cycloolefin copolymer incorporates the residues of norbornene. The residues of ethylene and propylene may also be present in the cycloolefin copolymer. Suitably, the cycloolefin copolymer consists essentially of the residues of norbornene and ethylene, having a typical norbornene content of about 20-50 mol %. In preferred embodiments, the cycloolefin copolymer has a norbornene content between about 30-40 mol % and the norbornene usually has a glass transition temperature of at least about 70° C.

The method of the present invention may also employ a food contact layer that consists essentially of cycloolefin copolymer. The food contact layer is generally about 0.5-50 microns and is usually present in the films in an amount of between about 1 and about 10 microns, and preferably between about 2 to about 7 microns.

The food contact layer of the present invention is usually adhered to a polyethylene layer, and in preferred embodiments the polyethylene layer comprises low density polyethylene (“LDPE”) or linear low density polyethylene (“LLDPE”). The food contact layer may also be adhered to a polypropylene layer.

The cycloolefin food contact layers in the films of the present invention have a low extractable concentration and typically exhibit a volatile out-gas profile of less than about 30 ng, and preferably less than about 20 ng, of volatiles per square cm of surface area when heated to 80° C. for 30 minutes in a solid sample purge and trap apparatus. Generally, the cycloolefin copolymer layers of the present invention should exhibit a volatile out-gas profile of oligomers in the amount of less than about 5 ng per square cm when heated to 80° C. for 30 minutes in a solid sample purge and trap apparatus. The cycloolefin layers can typically be characterized as having a concentration of less than about 10 ng of total extractables, preferably less than about 6 ng of which are oligomers, per square cm of surface area to a 40 ml solution of 10% ethanol in distilled water after being incubated for 24 h at 60° C. with constant agitation.

The invention also provides for a way to reduce the transport of a consumable's flavor compounds into a polyolefin layer by employing a food contact layer that consists essentially of a cycloolefin copolymer with a glass transition temperature of at least 70° C.

Another aspect of the present invention is a container for receiving a consumable which comprises a structural member of one or more layers defining the container's shape including an interior wall. There is also a food contact layer which is adhered to the interior of the structural member; the food contact layer has a thickness from about 0.5 to about 50 microns. The food contact layer should comprise at least 75 wt. % cycloolefin copolymer and is characterized by having an extractable concentration of less than about 30 ng per cm² of surface area when incubated in a 40 ml solution of 10% ethanol in distilled water for 24 hours at 60° C. with constant agitation. The container is typically a blow-molded or thermoformed container, and may be a bag, a pouch, a bottle, a paperboard container, or the like.

Yet another aspect of the present invention is a flavor-preserving film that has either a polyethylene or polypropylene layer and a food contact layer with a cycloolefin copolymer content of at least 75 wt. %. The food contact layer has a thickness of about 0.5 to 50 microns and the cycloolefin copolymer has a glass transition temperature of at least about 70° C., and preferably at least about 75° C. The food contact layer of the flavor-preserving film preferably consists essentially of a cycloolefin copolymer. In an especially preferred embodiment the cyloolefin copolymer consists essentially of the residues of norbornene and ethylene. Polyethylene is an acceptable material for the polyolefin layer, and LDPE or LLDPE are particularly suitable.

The packaging of the present invention exhibits unexpectedly low extractables as compared with, for example, polyethylenes used in food packaging, notwithstanding similarities in production methods, solvents, and oligomer content. Without intending to be bound by any theory, it is believed the “glassy” nature of the polymer prevents flavor-impairing agents from migrating to or from the packaged food.

Further embodiments and advantages of the present invention will be readily apparent from the detailed description discussed below.

### BRIEF DESCRIPTION OF DRAWINGS

The invention is described in detail below in connection with the appended drawings wherein like numerals designate like parts and wherein:

FIG. 1 illustrates a container made with the films of the present invention.

FIG. 1a is an enlarged cross-section of a wall of the container in FIG. 1 and shows the multilayer structure of the films of the present invention.

FIG. 2 is a graphical representation of the total volatile out-gas profile and the amount of volatile out-gas oligomers.

FIG. 3 is a graphical representation of the total amount of extractables and the amount of extractable oligomers.

FIG. 4 is a GC-MS chromatogram of a method analysis blank that has been assayed according to the procedure described in Example 2.

FIG. 5 is a GC-MS chromatogram of a film sample of 100% LLDPE (Dow 2045) that has been assayed according to the procedure described in Example 2.

FIG. 6 is a GC-MS chromatogram of a film sample of 100% COC (Topas® 8007) that has been assayed according to the procedure described in Example 2.

### DETAILED DESCRIPTION OF THE INVENTION

The invention is described in detail below with reference to numerous embodiments for purposes of exemplification and illustration only. Modifications to particular embodiments within the spirit and scope of the present invention, set forth in the appended claims, will be readily apparent to those of skill in the art.

Unless more specifically defined, terminology is given its ordinary meaning.

“Consumable” or “consumables” as used herein refers to food or beverage items that are able or meant to be consumed.

“Scalping” refers to the phenomenon by which flavor and/or aroma compounds from a consumable are transported into or absorbed by a plastic.

“Surface area” when used in reference to the surface area of a film refers herein to the film's one-side surface area.

“Volatiles,” “volatile out-gas compounds,” and like terminology refers to the compounds that are exhausted by a plastic film when placed in a solid sample purge and trap apparatus and heated at a given temperature for a given time. As it is referred to in this specification, the volatile out-gas products are purged with nitrogen at a rate of 40 ml/minutes before analysis. When the concentration of volatiles is reported as “ng/cm²” it refers to nanograms of volatiles per square cm of surface area, based on the sample film's one-side surface area. “Volatiles” exhausted by the films of the present invention may include but are not limited to the following compounds: toluene, benzene, dimethyl cyclopentadiene, vinyl cyclopentane, methyl, ethylcyclopentene, 2-methylbicycloheptane, cyclooctadiene, 2-cyclopente-1-one, norbornane, cyclohexene, vinyl cyclohexene, hexanal, heptanal, octanal, ethyl benzene, m & p xylene, o-xylene, styrene, 2-heptanone, 2-butoxyethanol, benzaldehyde, p-dichlorobenzene, 2-ethylhexyl alcohol, cyclohexanone, acetophenone, benzophenone, benzaldehyde, 2-nonanone, cis-decalin, trans-decalin, decalin analogues, nonanal, decanal, undecanal, dodecanal, tridecanal, tetradecanal, limionene, dipropylene glycol, trans-2nonenal, and oligomers.

“Extractable,” “extractables,” and like terminology refer to compounds which are leached from a polymer. Specifically, the phrase “having an extractable concentration,” or like terminology, refers to the concentration of extractable compounds that a film imparts to a given consumable or solution at a given time and temperature. The concentration is usually reported in nanograms per square centimeter of film surface area, based on its one-side surface area. Extactable compounds in polymers may come from a wide variety of sources including, residual catalysts, antioxidants, extrusion adhesives, rogue carbonyl groups, residual monomers, and other impurities. Extractables may include but are not limited to heptanal, 2-butoxyethanol, benzaldehyde, phenol, 2-ethylhexyl alcohol, acetophenone, naphthalene, 2-phenoxyethanol, benzothiazole, biphenyl, 2-octanone, octanal, nonanal, heptanoic acid, octanoic acid, nonanoic acic, decanoic acid, dodecanoic acid, tridecanoic acid, undecanoic acid, decalin analogues, biphenyl, methyl biphenyl, 2,6-di-t-butylbenzoquionone, 2,6-di-t-butylphenol, 3,5-di-t-butylhydroquinone, 2,6-di-t-butyl-p-ethylphenol, 2,6,-bis-(t-butyl)-4-dimethylbenzylphenol, 2,4,6-tri-(dimethylbenzyl)phenol, myristic acid, Irganox® (Ciba-Geigy) decomposition products, palmitic acid, and oligomers.

“Oligomer” and “oligomers” refer to polymeric compounds having a small number of monomer units, e.g. dimer, trimer, tetramer, etc. Oligomers include, but are not limited to, homologous series of even numbered C₆-C₁₈ hydrocarbons, branched and linear paraffins and olefins, n-paraffins and linear alpha-olefins, alkyl-cycloparaffins, dienes, cycloolefins, branched chain hydrocarbons in the C₁₆ range, naphthalene, methylnaphthalene biphenyl, methylbiphenyl, and phenanthrene naphthenic hydrocarbons such as alky-decalins.

“Polyethylene” refers to refers to any polymer with the following general formula: (H₂C—CH₂)ₙ. Polyethylene includes LDPE, LLDPE, and high density polyethylene (“HDPE”). Methods of manufacturing polyethylene are well known in the art. Processes for producing polypropylene are also well known in the art.

As stated, the films of the present invention employ a layer of either polyethylene or polypropylene, and a layer of at least 75 wt. % cycloolefin copolymers. Useful cycloolefin copolymers are known in the art. For example, U.S. Pat. No. 6,068,936 (Assignee: Ticona GmbH) and U.S. Pat. No. 5,912,070 (Assignee: Mitsui Chemicals, Inc.) disclose several cycloolefin copolymers, the disclosures of which are incorporated herein in their entirety by reference. Cycloolefin copolymers include cycloolefin monomers and acycloolefin monomers, described further below.

Cycloolefins are mono- or polyunsaturated polycyclic ring systems, such as cycloalkenes, bicycloalkenes, tricycloalkenes or tetracycloalkenes. The ring systems can be monosubstituted or polysubstituted. Preference is given to cycloolefins of the formulae I, II, III, IV, V or VI, or a monocycloolefin of the formula VII: 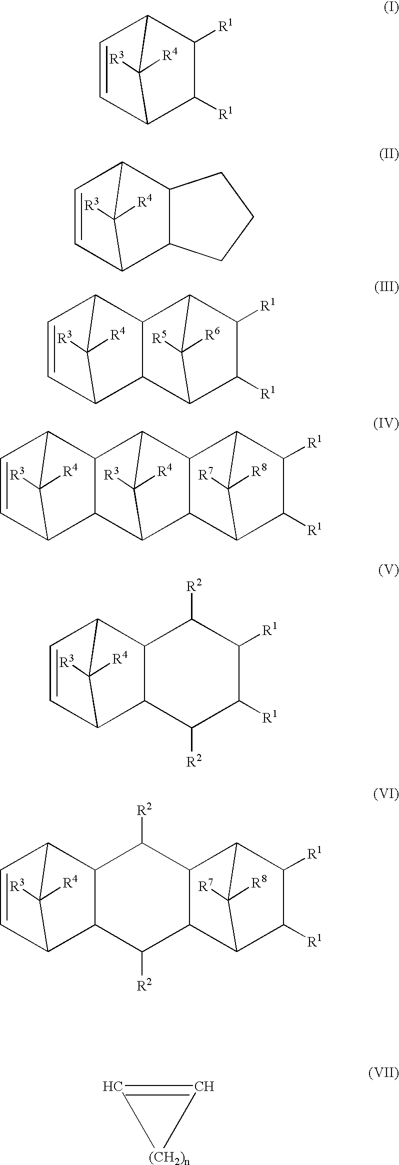
wherein R¹, R², R³, R⁴, R⁵, R⁶, R⁷ and R⁸ are the same or different and are H, a C₆-C₂₀-aryl or C₁-C₂₀-alkyl radical or a halogen atom, and n is a number from 2 to 10. Examples of such cycloolefin monomers are norbornene, dimethyl-octahydro-naphthalene, cyclopentene and (5-methyl)norbornene and the like, or mixtures thereof. These monomers can also be polymerized with acyclic comonomers. Examples of suitable acycloolefin monomers which may be polymerized with the cyclo-olefins noted above are ethylene, propylene, butylene and the like, or mixtures thereof. A preferred cycloolefin is norbornene, and a preferred acycloolefin for reaction therewith is ethylene. Cycloolefin copolymers are commercially available and an acceptable copolymer includes Topas® 8007F04, manufactured by Ticona.

The cycloolefin polymers can be prepared with the aid of transition-metal catalysts, e.g. metallocenes. Suitable preparation processes are known and described, for example, in DD-A-109 225, EP-A-0 407 870, EP-A-0 485 893, U.S. Pat. Nos. 6,489,016, 6,008,298, 6,608,936, and 5,912,070, the disclosures of which are incorporated herein in their entirety by reference. Molecular weight regulation during the preparation can advantageously be effected using hydrogen. Suitable molecular weights can also be established through targeted selection of the catalyst and reaction conditions. Details in this respect are given in the abovementioned specifications.

The layers of the present invention may also be blended with additional polymers that do not frustrate the intended purpose of the invention. The cycloolefin layer may only contain up to 25 weight percent of additional polymers. The polyolefin layer should contain a substantial amount of polyethylene or polypropylene. These polyolefins should preferably comprises more than 50 wt. % of the polyolefin layer. Other suitable polymers that may be included in blends to form the layers of the films of the present invention include other polyolefins, such as homopolymer and copolymers of C₂-C₄₀ α-olefins, also acceptable are homopolymers and copolymers of esters, amides acetates, and anhydrides.

The films may further include more than one layer comprising cycloolefin and more than one layer comprising polyethylene. The polyethylene layer and cycloolefin may also be configured with other layers. Tie, or adhesive, layers may be used to bind the separate layers. Any layer that is capable of being configured with the films of the present invention may be included so long as it does not frustrate an intended purposes of the invention. Acceptable layers that may be present with the layers in the films of the present invention include layers comprising other polyolefins, for example any homopolymer or copolymer of C₂-C₄₀ α-olefins; polar polymers, for example homopolymers and copolymers of esters, amides, acetates, and anhydrides; and other layers such as paper, cardboard, kraft paper, wood, metal, metal foils, metallized surfaces, glass, fabric, other fibers, and surfaces coated with substrates such as ink, dye, and the like. It will also be apparent to one ordinarily skilled in the art that additives may be added to one or more layers in the films of the present invention. Acceptable additives include lubricants, dyes, pigments, antioxidants, fillers, processing aids, UV stabilizers, neutralizers, antiblock, or the like.

The layers in the films of the present invention may be arranged in any configuration with the proviso that the inner, or consumable contacting, layer must be the cycloolefin layer. For example, where “A” is the polyethylene layer and “B” is an adhesive layer and “C” is the cycloolefin layer, the following are acceptable configurations: A/C, A/B/C, C/B/A/B/C, C/A/C, where in each embodiment the inner cycloolefin layer is positioned to be in contact with the consumable. The cycloolefin layer has been found to exhibit remarkably good extractable and scalping properties even in small amounts. The cycloolefin layer typically varies in thickness from about 0.5 to 50 microns, and is usually present in an amount from 2 to 7 microns. The polyethylene layer may vary broadly depending on the intended applications. In a preferred embodiment the polyethylene layer is from about 0.2-1.5 mm thick.

The films of the present invention may be prepared by any process suitable for making multilayered films. Acceptable processes include co-extrusion, lamination, and two-shot injection molding. Co-extrusion and lamination are preferred processes for making the films of the present invention. Co-extrusion is a well known process to make multilayer films. U.S. Pat. Nos. 3,479,425; 3,959,431; and 4,406,547, the entireties of which are herein incorporated by reference, describe co-extrusion processes whereby multilayered plastic films are formed. Typically, co-extrusion processes bring the separate polymeric melt streams together within multimanifold die which distributes the polymer layers uniformly and adheres them to each other either inside the die or outside the die. A multimanifold die is a die having an individual manifold for each layer, and is usually flat or annular. Once the film exits the extruder die it is typically fed to a take-off roll, or rolls, on which the extruded film is cooled and solidified.

Another suitable method for making the multilayered films is lamination. The multilayered films can be laminated simply by superimposing at least one polymeric layer on the other polymeric layer and bonding the layers together using heat. Yet another acceptable method for combining the layers is by two-shot injection molding. In two-shot injection molding, a first polymeric material is injected into a mold cavity until it contacts the wall of the mold, then a second polymeric material is immediately injected into the mold cavity, causing the second polymeric material to adhere to the first polymeric material. This process can be repeated to form articles incorporating many layers. A combination of the above processes can also be employed. For example, a film comprising a layer of cycloolefin copolymer and a layer of polyethylene might be co-extruded and subsequently laminated onto a paperboard layer.

If so desired, the films can be stretched longitudinally and transversely to the extrusion direction, which results in a biaxial orientation of the molecular chains. The biaxial orientation can be carried out simultaneously or successively, where successive biaxial stretching, in which stretching is carried out firstly in the longitudinal direction (in the machine direction) and then in the transverse direction (perpendicular to the machine direction), is particularly favorable. The allowable stretching ratios depend upon natural stretch ratios of the polymers in the film structure. The longitudinal stretching is expediently carried out with the aid of two rolls running at different speeds in accordance with the target stretching ratio, and the transverse stretching is carried out with the aid of an appropriate tenter frame. The temperatures at which the longitudinal stretching and the transverse stretching are carried out can vary within a broad range and depend on the particular composition of the layers and on the desired properties of the film. In general, the longitudinal stretching is carried out at from 80 to 150° C. The biaxial stretching of the film can be followed by heat-setting (heat treatment) thereof, during which the film is typically kept at a temperature of from 100 to 160° C., preferably from 110 to 130° C., or from about 0.1 to 10 seconds. An exact temperature depends on the specific combination of materials used in the film. The film is subsequently wound up in a conventional manner using a wind-up unit.

For certain applications it may also be desirable to oxidize the surface of the film or its individual layers by a corona- or flame-treatment, which can be performed by known methods for purposes of increasing wetting or adhesion.

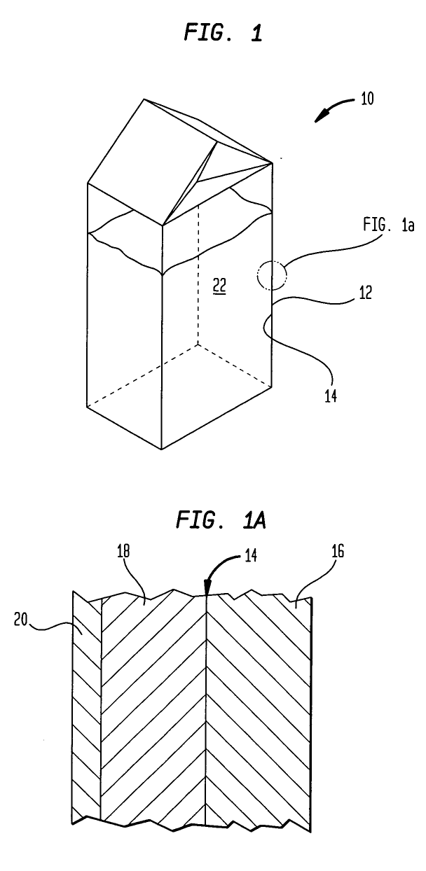

The films may be used to control leaching of extractables and flavor scalping from food, for example, when used as part of a food or beverage container. Suitable containers include bags, resealable bags, bottles, pouches, cartons, and paperboard containers. The containers of the present invention are particularly suitable for holding consumables which have a low flavor level, consumables which easily take on the flavor of extractable compounds, or consumables which are vulnerable to flavor scalping. Exemplary containers which can be made by the films of the present invention include containers for holding water, potato chips, and orange juice. FIGS. 1 and 1a illustrate a paperboard container 10 that incorporates a food contact layer in accordance with the present invention. Container 10 has a structural member 12 which includes an interior wall 14 with a paperboard layer 16 and a polyethylene layer 18 thereon disposed inwardly with respect to the paperboard. The interior wall of the structural member defines the contained volume of container 10. A cycloolefin layer 20 is disposed on layer 18 of wall 14 and in contact with layer 18 as well as a beverage 22 held by container 10. FIG. 1a is an enlarged cross-sectional view of the wall of container 10 showing a composite structure of the present invention as described above.

The packaging or containers provided by the present invention may be made by conventional means. For example, blow molding, stretch blow molding, extrusion blow molding, and thermoforming are all contemplated. Blow molding, is a process by which a hot parison incorporating, for example, the films of the present invention is expanded against the surfaces of a mold, typically using compressed air or other compressed gases. In stretch blow-molding the parisons may be injection molded, brought to the proper temperature and blown into the container in a continuous process. Stretch blow-molding may also occur in a multistage process where the parisons are formed and then stored, and are later blown into containers using a reheat-blow machine. Extrusion blow molding employs standard blow molding techniques where the parison is produced by extrusion. Thermoforming is also a well-known process which converts an extruded plastic sheet into the desired article, usually a thin-walled container. Generally, the extruded plastic sheet is heated into a formable condition and is moved over a mold and made to contact the mold by applying pressure or using a vacuum. The plastic assumes the shape of the mold and excess plastic may be trimmed and recycled. In some cases, the thermoforming process may be run in-line with the extruder. Of the above processes, stretch blow molding and extrusion blow molding are preferred to make the articles of manufacture of the present invention.

The compositions used in the present invention have excellent properties for retaining the original flavor of a consumable. The layers exhibit reduced extractables and low flavor scalping properties, as illustrated by the examples below.

The examples illustrate preferred compositions and methods of the present invention. These examples are illustrative only and do not limit the scope of the invention. In all examples, the samples are identified as follows:

| | |
|---|---|
| Sample A | 100% LLDPE (Dow 2045) |
| Sample B | 25% Topas COC 1 + 75% LLDPE |
| Sample C | 100% Topas COC 2 |
| Sample D | 100% Topas COC 1 |
| Sample E | 80% Topas COC 1 + 20% LLDPE |

The LLDPE is produced by Dow chemical and is reported to have the following properties:

| | |
|---|---|
| Density | 0.92 g/cm³ |
| Melt Flow | 1 g/10 min |
| Tensile Strength, Ultimate | 3800 psi |
| Vicat Softening Point | 106° C. |

The Topas® polymers are copolymers of norbornene and ethylene and are manufactured by Ticona. The COC 1 is believed to contain approximately 36 mol % nobornene content, balance ethylene and has a glass transition temperature of approximately 80° C. COC 2 contains less norbornene than the COC 1 grade and has a lower glass transition temperature, typically about 68° C. The above polymers were extruded under normal conditions to produce the film samples used in the examples below.

Unless otherwise indicated, the following test procedures are used to characterize the compositions and products of the invention.

### EXAMPLE 1

### Volatile Out-Gas Profiling

In order to evaluate the odor properties of the film samples, the samples in Table 1 were subjected to volatile out-gas profiling using Purge and Trap-Thermal Desorption-GS-MS analysis. The analysis proceeded as described below.

Approximately 1 g (200 cm² of one-side surface area) of each polymer sample was measured into a Scientific Instrument Services, Inc. (SIS, Ringoes N.J.) solid sample purge and trap apparatus. The samples were spiked with internal standards (1.0 μg of d-8 toluene and d-8 napthalene) and then heated to 80° C. for 30 minutes. During this time, the volatile out-gas products from the films were purged with nitrogen at a rate of 40 ml/min and were trapped and concentrated on Tenax-TA adsorbent cartridges. The adsorbent trap had an adsorbent trap bed volume of 6 cm. The GLT desorption tube had an inside diameter was 3mm. The thermal desorption temperature was set to 250° C., the desorption time was 5 minutes, and the injection time was 30 seconds. The initial purge time was 10 seconds and the type of analysis was GC-MS. The Tenax traps were then analyzed by Short Path Thermal Desorption-GC-MS. The assay included the following GC conditions. A Varian 3400 instrument having a column of Δ8S-Ms, a length of 30 m, a diameter of 0.32 mm and a film thickness of 0.25 mm. A split thermal desorption type of injection was used at an injector temperature of 250° C. A septum purge was used with a split ratio of 100:1. The carrier gas flow was an HP carrier flow with a PSI head pressure of 10 PSI. The temperature program was from −20° C. for 5 minutes to 280° C. @ 10° C./minute. The GC-MS interface line temperature was 280° C. The Mass Spectrometer conditions included a Finnigan MAT 8230 instrument and a Finnigan MAT SS300 data system. The ionization mode was EI (70 eV) with positive ion, and ion source temperature of 250° C. The filament emission current was 0.5 μAmp. The mass range was 35-350, a scan rate was 0.6s/Δ, interscan time was 0.8 seconds, and resolution was 1000.

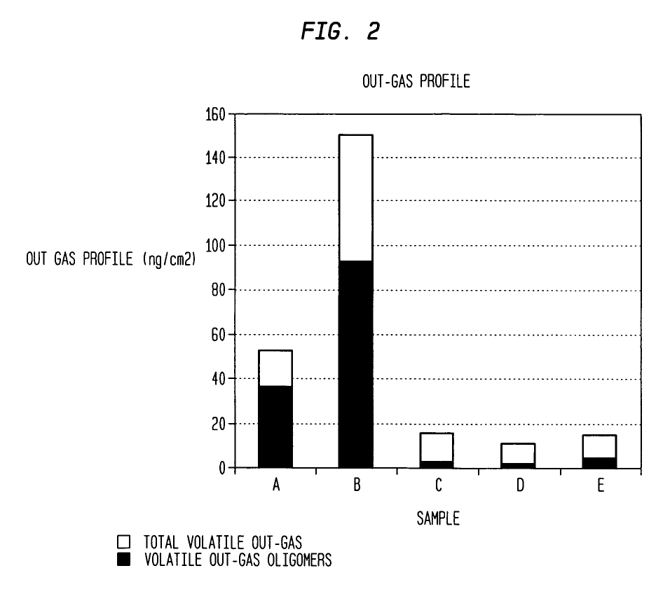

A method analysis blank containing internal standards only was prepared and analyzed alongside the film samples as a control. The results for volatile out-gas profiling are detailed in Table 1 below and are illustrated graphically in FIG. 2. In the table, the peak assignment for each compound is identified as well its concentration in ng/cm² and PPB w/w.

TABLE 1
Comparisons of Volatile Out-Gas Profiles of Samples

| | | | B | | C | | | | E | |
|---|---|---|---|---|---|---|---|---|---|---|
| | A | | 25% Topas + | | 100% Topas COC, | | D | | 80% Topas COC + | |
| | 100% LLDPE | | 75% LLDPE | | low Tg | | 100% Topas COC | | 20% LLDPE | |
| Table 1 | Conc. | Conc. | Conc. | Conc. | Conc. | Conc. | Conc. | Conc. | Conc. | Conc. |
| Peak Assignment | PPB w/w | ng/cm2 | PPB w/w | ng/cm2 | PPB w/w | ng/cm2 | PPB w/w | ng/cm2 | PPB w/w | ng/cm2 |
| cyclohexene | — | — | — | — | 8.69 | 0.04 | — | — | — | — |
| benzene | — | — | — | — | 5.64 | 0.03 | 4.86 | 0.03 | — | — |
| dimethyl cyclopentadadiene isomer | — | — | — | — | 17.00 | 0.08 | — | — | — | — |
| vinyl cyclopentane | — | — | — | — | 26.70 | 0.13 | — | — | — | — |
| norbornane | — | — | — | — | 95.52 | 0.45 | — | — | — | — |
| d-8 toluene (internal standard) | 990.10 | 5.00 | 900.90 | 5.00 | 1063.83 | 5.00 | 952.38 | 5.00 | 1000.00 | 5.00 |
| toluene | 8.09 | 0.04 | 19.70 | 0.11 | 24.42 | 0.11 | 35.99 | 0.19 | 22.69 | 0.11 |
| vinyl cyclohexene (butadiene dimer) | — | — | — | — | 37.91 | 0.18 | — | — | — | — |
| hexanal | 2.71 | 0.01 | 2.06 | 0.01 | 13.29 | 0.06 | 24.24 | 0.13 | 2.50 | 0.01 |
| methyl, ethylcyclopentene | — | — | — | — | 112.33 | 0.53 | — | — | — | — |
| 2-methylbicycloheptane | — | — | — | — | 738.23 | 3.47 | — | — | — | — |
| cyclooctadiene | — | — | — | — | 20.13 | 0.09 | — | — | — | — |
| 2-cyclopenten-1-one | — | — | — | — | 47.57 | 0.22 | — | — | — | — |
| ethyl benzene | — | — | 6.34 | 0.04 | 5.29 | 0.02 | 3.61 | 0.02 | 3.56 | 0.02 |
| m & p-xylene | — | — | 25.80 | 0.14 | 12.56 | 0.06 | 8.89 | 0.05 | 6.58 | 0.03 |
| o-xylene | — | — | 7.02 | 0.04 | 5.41 | 0.03 | 4.57 | 0.02 | 4.27 | 0.02 |
| styrene | — | — | 10.91 | 0.06 | 5.37 | 0.03 | 7.47 | 0.04 | 7.86 | 0.04 |
| cyclohexanone | — | — | — | — | 10.63 | 0.05 | — | — | — | — |
| 2-heptanone | — | — | 6.06 | 0.03 | — | — | — | — | — | — |
| heptanal | 10.08 | 0.05 | 17.83 | 0.10 | 17.08 | 0.08 | 14.29 | 0.08 | 3.05 | 0.02 |
| dimethylbicycloheptane | — | — | — | — | 57.15 | 0.27 | — | — | — | — |
| ethylbicycloheptane | — | — | — | — | 154.11 | 0.72 | — | — | — | — |
| C-9 diene isomers | — | — | — | — | 49.73 | 0.23 | — | — | — | — |
| 2-butoxyethanol | — | — | 56.06 | 0.31 | — | — | — | — | — | — |
| benzaldehyde | — | — | 103.16 | 0.57 | 21.06 | 0.10 | 13.17 | 0.07 | 15.89 | 0.08 |
| 2-norbornanone | — | — | — | — | 34.04 | 0.16 | — | — | — | — |
| octanal | 13.17 | 0.07 | 7.48 | 0.04 | 20.52 | 0.10 | 16.93 | 0.09 | 4.43 | 0.02 |
| limonene | — | — | — | — | — | — | 158.95 | 0.83 | — | — |
| dipropylene glycol (DPG) | — | — | — | — | — | — | 126.46 | 0.66 | — | — |
| p-dichlorobenzene | — | — | 22.15 | 0.12 | — | — | — | — | — | — |
| 2-ethylhexyl alcohol | — | — | 188.14 | 1.04 | — | — | — | — | — | — |
| cis-decalin | 127.67 | 0.64 | 4066.49 | 22.57 | — | — | 494.46 | 2.60 | 853.37 | 4.27 |
| acetophenone | — | — | 46.60 | 0.26 | — | — | — | — | — | — |
| 2-nonanone | — | — | 16.27 | 0.09 | — | — | — | — | — | — |
| trans-decalin | 545.16 | 2.75 | 4863.38 | 26.99 | — | — | 703.93 | 3.70 | 1128.17 | 5.64 |
| nonanal | 60.36 | 0.30 | 55.96 | 0.31 | 83.74 | 0.39 | 47.52 | 0.25 | 14.89 | 0.07 |
| trans-2-nonenal | — | — | — | — | — | — | 8.15 | 0.04 | — | — |
| d-8 naphthalene (internal standard) | 1024.20 | 5.17 | 923.97 | 5.13 | 1086.24 | 5.11 | 972.99 | 5.11 | 1003.18 | 5.02 |
| decanal | 135.55 | 0.68 | 213.44 | 1.18 | 27.09 | 0.13 | 49.29 | 0.26 | 13.32 | 0.07 |
| undecanal | 107.97 | 0.55 | 192.96 | 1.07 | 3.75 | 0.02 | 1.93 | 0.01 | 1.16 | 0.01 |
| 208 m.w. decalin analogue | 45.58 | 0.23 | 67.79 | 0.38 | — | — | 0.68 | 0.00 | 2.73 | 0.01 |
| dodecanal | 82.47 | 0.42 | 51.56 | 0.29 | 1.00 | 0.00 | 0.39 | 0.00 | 4.30 | 0.02 |
| tridecanal | 86.96 | 0.44 | 40.97 | 0.23 | 0.70 | 0.00 | 0.71 | 0.00 | 0.32 | 0.00 |
| tetradecanal | 29.52 | 0.15 | 22.54 | 0.13 | 0.66 | 0.00 | 0.48 | 0.00 | 0.58 | 0.00 |
| benzophenone | — | — | 40.29 | 0.22 | — | — | — | — | — | — |
| mixture of short chain polyethylene | 7221.19 | 36.47 | — | — | — | — | — | — | — | — |
| oligomers: | | | | | | | | | | |
| homologous series of even numbered | | | | | | | | | | |
| C-6-C-18 hydrocarbons | | | | | | | | | | |
| branched and linear paraffins & | | | | | | | | | | |
| olefins | | | | | | | | | | |
| primarily n-paraffins and linear | | | | | | | | | | |
| alpha-olefins | | | | | | | | | | |
| more branched chain hydrocarbons | | | | | | | | | | |
| in the C-16 range | | | | | | | | | | |
| traces of naphthalene, | | | | | | | | | | |
| methylnaphthalene, biphenyl, | | | | | | | | | | |
| methylbiphenyl & phenanthrene | | | | | | | | | | |
| traces of naphthenic hydrocarbons | | | | | | | | | | |
| such as alky-decalins | | | | | | | | | | |
| mixture of short chain polyethylene + | — | — | 16747.38 | 92.95 | — | — | — | — | — | — |
| Topas COC oligomers: | | | | | | | | | | |
| homologous series of even numbered | | | | | | | | | | |
| C-6-C-18 hydrocarbons | | | | | | | | | | |
| branched and linear paraffins, | | | | | | | | | | |
| olefins and alkyl-cycloparaffins | | | | | | | | | | |
| primarily n-paraffins and linear | | | | | | | | | | |
| alpha-olefins | | | | | | | | | | |
| more branched chain hydrocarbons | | | | | | | | | | |
| in the C-16 range | | | | | | | | | | |
| this sample has more olefin content | | | | | | | | | | |
| and dienes than the 100% LLDPE film | | | | | | | | | | |
| traces of naphthalene, | | | | | | | | | | |
| methylnaphthalene, biphenyl, | | | | | | | | | | |
| methylbiphenyl & phenanthrene | | | | | | | | | | |
| traces of naphthenic hydrocarbons | | | | | | | | | | |
| such as alky-decalins | | | | | | | | | | |
| mixture of short chain Topas COC | — | — | — | — | 608.04 | 2.86 | — | — | — | — |
| oligomers: | | | | | | | | | | |
| homologous series of C-6-C-18 | | | | | | | | | | |
| hydrocarbons | | | | | | | | | | |
| branched and linear paraffins, | | | | | | | | | | |
| olefins, dienes, cycloolefins, | | | | | | | | | | |
| bicyclics & alkyl-cycloparaffins | | | | | | | | | | |
| only traces of n-paraffins and | | | | | | | | | | |
| linear alpha-olefins | | | | | | | | | | |
| mostly polyunsaturated species | | | | | | | | | | |
| (dienes, cyclooefins, bicyclics etc.) | | | | | | | | | | |
| this sample has much more olefin | | | | | | | | | | |
| content and dienes than the 100% | | | | | | | | | | |
| LLDPE film | | | | | | | | | | |
| mixture of short chain Topas COC | — | — | — | — | — | — | 422.70 | 2.22 | — | — |
| oligomers: | | | | | | | | | | |
| homologous series of even numbered | | | | | | | | | | |
| C-6-C-18 hydrocarbons | | | | | | | | | | |
| primarily n-paraffins and linear | | | | | | | | | | |
| alpha-olefins | | | | | | | | | | |
| this sample has a very low out-gas | | | | | | | | | | |
| profile of short chain hydrocarbons | | | | | | | | | | |
| compared to other samples | | | | | | | | | | |
| traces of naphthenic hydrocarbons | | | | | | | | | | |
| such as alky-decalins | | | | | | | | | | |
| mixture of short chain polyethylene + | — | — | — | — | — | — | — | — | 940.23 | 4.70 |
| Topas COC oligomers: | | | | | | | | | | |
| homologous series of even numbered | | | | | | | | | | |
| C-6-C-18 hydrocarbons | | | | | | | | | | |
| primarily n-paraffins and linear | | | | | | | | | | |
| alpha-olefins | | | | | | | | | | |
| this sample has a very low out-gas | | | | | | | | | | |
| profile of short chain hydrocarbons | | | | | | | | | | |
| compared to other samples | | | | | | | | | | |
| traces of naphthenic hydrocarbons | | | | | | | | | | |
| such as alky-decalins | | | | | | | | | | |
| Total Out-Gas Products @ 80 C./30 | 8476.50 | 52.98 | 26898.33 | 149.29 | 3329.21 | 15.65 | 2149.67 | 11.29 | 3029.92 | 15.15 |
| Min. | | | | | | | | | | |

As can be seen from Table 1, the volatile out-gas values attributable to the films (in ng per cm² of film surface area) was approximately 53 for Sample A, 149 for Sample B, 16 for Sample C, 11 for Sample D, and 15 for Sample E. The oligomer content of the total volatile out-gas profile of the samples (in ng/cm²) was 36 for Sample A, 93 for Sample B, 2.9 for Sample C, 2.2 for Sample D, and 4.7 for Sample E. FIG. 2 shows the total volatile out-gas values of the films and the oligomer out-gas values.

The results from Table 1 illustrate that the cycloolefin copolymers contain much fewer volatile out-gas compounds than the polyethylene, including fewer oligomers. Similarly, in the blended polymers, blends with a higher percentage of COC (as in Sample E) had a lower amount of volatiles.

Films having the same composition as those used in Example 1, were tested for extractable content in an assay that is described in detail in Example 2, below.

### EXAMPLE 2

### Extractables Testing

Film samples were weighed out to about 1.0 g and their one-side surface area was approximately 200 cm². Samples were cut into small sections of approximately 1 cm² and placed in a 50 ml test tube containing 40 ml of 10% ethanol in distilled water sealed with a Teflon-lined screw cap closure. Tubes were tightly stoppered and then incubated at 60° C. for 24 hours with constant agitation. Following incubation, the tubes were cooled to room temperature and the film removed. Internal standard (anthracene-d₁₀) at a concentration equivalent to approximately 100 PPB w/w (1.0 μg) relative to film sample weights was spiked into the tubes along with 10.0 ml of methylene chloride. Samples were agitated and the extraction solutions were centrifuged at 2000 RPM for 30 minutes to promote complete phase separation. Lower methylene chloride layers were transferred to 5 ml size, conical-bottomed vials and concentrated under a gentle stream of nitrogen at room temperature to a final volume of approximately 10.0 extracts were then analyzed by GC-MS using conditions optimized for polymer extractables testing. Details of the sample preparation and analysis conditions for extractables testing are additionally as follows: The analysis included the following GC conditions. A Varian 3400 instrument having a column of DBS-MS, a length of 30 m, a diameter of 0.32 mm and a film thickness of 0.25 mm. A splitless type of injection was used with a 2 mm direct injection liner, having an injection volume of 1.0 ml at an injector temperature of 260° C. A septum purge was used with a split ratio of 100:1 after 0.5 minutes. Carrier gas flow was an HP carrier flow with a PSI head pressure of 10 PSI. The temperature program was from 50° C. for 3 minutes to 320° C. @ 10° C./minute. The GC-MS interface line temperature was 320° C. GC maintenance included a septum change, clean and silanize injection liner, and column bakeout. Mass Spectrometer conditions included a Finnigan MAT 8230 instrument and a Finnigan MAT SS300 data system. Ionization mode was EI (70 eV) with positive ion, and ion source temperature of 250° C. Filament emission current was 0.5 μAmp. A mass range was 35-650, a scan rate was 0.6 s/D, and interscan time was 0.8 seconds, and resolution was 1000.

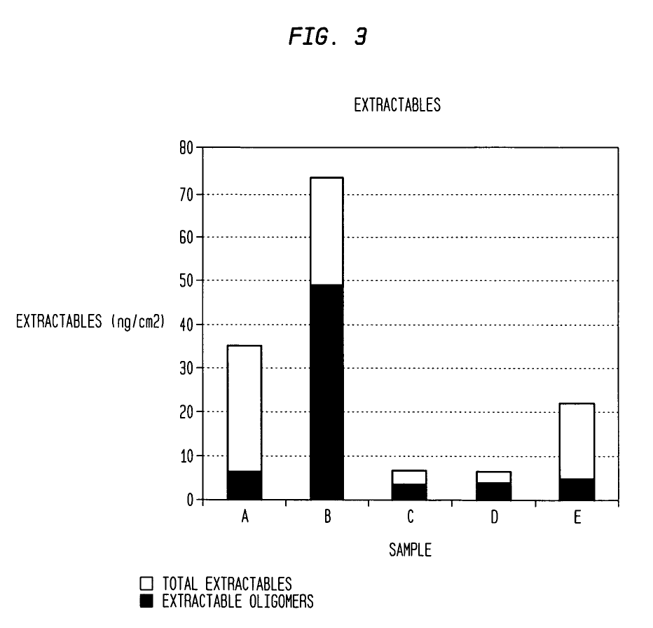

A method analysis blank was performed and analyzed alongside the film samples and consisted of all reagents and work up procedure except for the absence of film. Compounds detected in the method blank were ignored in the data treatment of the authentic film samples. Results of the extractables tests are shown in Table 2. In the table, the peak assignments of each extractable are identified as well its concentration in ng/cm² and PPB w/w. FIG. 3 illustrates graphically the results of the extractable testing.

TABLE 2
Comparisons of Extractables Profiles of Samples

| | | | B | | C | | | | E | |
|---|---|---|---|---|---|---|---|---|---|---|
| | A | | 25% Topas COC + | | 100% Topas COC, | | D | | 80% Topas COC + | |
| | 100% LLDPE | | 75% LLDPE | | low Tg | | 100% Topas COC | | 20% LLDPE | |
| Table 2 | Conc. | Conc. | Conc. | Conc. | Conc. | Conc. | Conc. | Conc. | Conc. | Conc. |
| Peak Assignment | PPB w/w | ng/cm2 | PPB w/w | ng/cm2 | PPB w/w | ng/cm2 | PPB w/w | ng/cm2 | PPB w/w | ng/cm2 |
| heptanal | 37.40 | 0.20 | 68.41 | 0.30 | 23.64 | 0.12 | 21.82 | 0.10 | 15.62 | 0.07 |
| 2-butoxyethanol | 11.15 | 0.06 | 17.64 | 0.08 | 10.75 | 0.05 | 6.75 | 0.03 | 6.68 | 0.03 |
| 1-butoxy-2-propanol | — | — | — | — | — | — | — | — | 2502.31 | 11.76 |
| benzaldehyde | — | — | 41.25 | 0.18 | — | — | 19.58 | 0.09 | — | — |
| phenol | — | — | 49.60 | 0.22 | 31.34 | 0.16 | — | — | — | — |
| 2-ethylhexyl alcohol | — | — | 59.59 | 0.27 | — | — | — | — | — | — |
| acetophenone | — | — | 9.64 | 0.04 | — | — | — | — | — | — |
| 2-octanone | 10.48 | 0.06 | — | — | — | — | — | — | — | — |
| octanal | 9.75 | 0.05 | — | — | — | — | — | — | — | — |
| heptanoic acid | 15.55 | 0.08 | 10.72 | 0.05 | 1.80 | 0.01 | 2.95 | 0.01 | — | — |
| nonanal | 13.99 | 0.07 | 39.56 | 0.18 | — | — | 9.16 | 0.04 | 14.33 | 0.07 |
| octanoic acid | 54.77 | 0.29 | 32.39 | 0.14 | 5.41 | 0.03 | 3.58 | 0.02 | 5.54 | 0.03 |
| decanal | — | — | — | — | — | — | 7.27 | 0.03 | 61.68 | 0.29 |
| naphthalene | — | — | 19.67 | 0.09 | — | — | — | — | — | — |
| 2-phenoxyethanol | — | — | 12.80 | 0.06 | — | — | — | — | — | — |
| benzothiazole | — | — | 18.68 | 0.08 | — | — | — | — | — | — |
| nonanoic acid | 228.60 | 1.20 | 21.06 | 0.09 | 33.83 | 0.17 | 4.77 | 0.02 | 21.46 | 0.10 |
| 208 m.w. decalin analogue | 119.86 | 0.63 | 217.33 | 0.97 | — | — | — | — | — | — |
| decanoic acid | 278.51 | 1.46 | 251.66 | 1.12 | 57.43 | 0.29 | 5.73 | 0.03 | 24.77 | 0.12 |
| biphenyl | 4.18 | 0.02 | 5.45 | 0.02 | — | — | — | — | — | — |
| 2,6-di-t-butylbenzoquionone (Irganox | 15.89 | 0.08 | 42.29 | 0.19 | — | — | — | — | — | — |
| antioxidant decomposition pro | | | | | | | | | | |
| undecanoic acid | 91.52 | 0.48 | 44.36 | 0.20 | 15.95 | 0.08 | — | — | — | — |
| 224 m.w. decalin analogue | 6.27 | 0.03 | 11.80 | 0.05 | — | — | — | — | — | — |
| 2,6-di-t-butylphenol (antioxidant) | 131.96 | 0.69 | 181.78 | 0.81 | — | — | 10.02 | 0.05 | 2.29 | 0.01 |
| methyl biphenyl | — | — | 11.93 | 0.05 | — | — | — | — | — | — |
| dodecanoic acid | 238.73 | 1.49 | 301.30 | 1.34 | 40.03 | 0.20 | 19.67 | 0.09 | 14.14 | 0.07 |
| tridecanoic acid | 15.94 | 0.08 | 25.81 | 0.11 | 17.71 | 0.09 | 1.79 | 0.01 | 1.03 | 0.00 |
| 3,5-di-t-butylhydroquinone | 23.21 | 0.12 | — | — | — | — | — | — | — | — |
| (antioxidant decomposition product) | | | | | | | | | | |
| 2,6-di-t-butyl-p-ethylphenol | 187.19 | 0.98 | — | — | — | — | — | — | — | — |
| (lonol II antioxidant) | | | | | | | | | | |
| myristic acid | 886.12 | 4.65 | 1153.78 | 5.13 | 128.93 | 0.64 | 91.32 | 0.43 | 106.51 | 0.50 |
| d-10 anthracene (internal standard) | 952.38 | 5.00 | 1123.60 | 5.00 | 1000.00 | 5.00 | 1052.63 | 5.00 | 1063.83 | 5.00 |
| mixture of Irganox antioxidant | 2490.34 | 13.07 | 2284.26 | 10.16 | — | — | — | — | 129.05 | 0.61 |
| decomposition products | | | | | | | | | | |
| palmitic acid | 487.86 | 2.56 | 664.78 | 2.96 | 242.38 | 1.21 | 338.10 | 1.61 | 715.23 | 3.36 |
| 2,6-bis-(t butyl)-4-dimethylbenzylphenol | 17.38 | 0.09 | — | — | — | — | — | — | — | — |
| (antioxidant related) | | | | | | | | | | |
| 2,4,6-tri-(dimethylbenzyl)phenol | 12.49 | 0.07 | — | — | — | — | — | — | — | — |
| (antioxidant related) | | | | | | | | | | |
| mixture of short chain polyethlene | 1248.16 | 6.55 | — | — | — | — | — | — | — | — |
| oligomers: | | | | | | | | | | |
| homologous serios of even numbered | | | | | | | | | | |
| C-6-C-18 hydrocarbons | | | | | | | | | | |
| branched and linear paraffins & olefins | | | | | | | | | | |
| primarily n-paraffins and linear | | | | | | | | | | |
| alpha-olefins | | | | | | | | | | |
| more branched chain hydrocarbons | | | | | | | | | | |
| in the C-16 range | | | | | | | | | | |
| traces of naphthalene, methylnaphthalene, | | | | | | | | | | |
| biphenyl, methylbiphenyl & phenanthrene | | | | | | | | | | |
| mixture of short chain polyethylene + | — | — | 10986.1 | 48.89 | — | — | — | — | — | — |
| Topas COC oligomers: | | | | | | | | | | |
| homologous series of even numbered | | | | | | | | | | |
| C-6-C-18 hydrocarbons branched and | | | | | | | | | | |
| linear paraffins, olefins and alkyl- | | | | | | | | | | |
| cycloparaffins | | | | | | | | | | |
| primarily n-paraffins and linear | | | | | | | | | | |
| alpha-olefins | | | | | | | | | | |
| more branched chain hydrocarbons in | | | | | | | | | | |
| the C-16 range | | | | | | | | | | |
| this sample has more olefin content | | | | | | | | | | |
| and dienes than the 100% LLDPE film | | | | | | | | | | |
| traces of naphthalene, methylnapthalene, | | | | | | | | | | |
| biphenyl, methylbiphenyl & phenanthrene | | | | | | | | | | |
| traces of naphthenic hydrocarbons | | | | | | | | | | |
| such as alky-decalins | | | | | | | | | | |
| mixture of short chain Topas COC | — | — | — | — | 751.03 | 3.76 | — | — | — | — |
| oligomers: | | | | | | | | | | |
| homologous series of C-6-C-18 | | | | | | | | | | |
| hydrocarbons | | | | | | | | | | |
| branched and linear paraffins, olefins, | | | | | | | | | | |
| dienes, cycloolefins, bicyclics & | | | | | | | | | | |
| alkyl-cycloparaffins | | | | | | | | | | |
| only traces of n-paraffins and linear | | | | | | | | | | |
| alpha-olefins | | | | | | | | | | |
| mostly polyunsaturated species | | | | | | | | | | |
| (dienes, cyclooefins, bicyclics etc.) | | | | | | | | | | |
| this sample has much more olefin | | | | | | | | | | |
| content and dienes than the 100% | | | | | | | | | | |
| LLDPE film | | | | | | | | | | |
| mixture of short chain Topas COC | — | — | — | — | — | — | 844.9 | 4.10 | — | — |
| oligomers: | | | | | | | | | | |
| homologous series of even numbered | | | | | | | | | | |
| C-6-C-18 hydrocarbons | | | | | | | | | | |
| primarily n-paraffins and linear | | | | | | | | | | |
| alpha-olefins | | | | | | | | | | |
| this sample has a very low out-gas | | | | | | | | | | |
| profile of short chain hydrocarbons | | | | | | | | | | |
| compared to other samples | | | | | | | | | | |
| traces of naphthenic hydrocarbons | | | | | | | | | | |
| such as alky-decalins | | | | | | | | | | |
| mixture of short chain polyethylene + | — | — | — | — | — | — | — | — | 1114.60 | 5.24 |
| Topas COC oligomers: | | | | | | | | | | |
| homologous series of even numbered | | | | | | | | | | |
| C-6-C-18 hydrocarbons | | | | | | | | | | |
| branched and linear paraffins, olefins | | | | | | | | | | |
| and alkyl-cycloparaffins | | | | | | | | | | |
| primarily n-paraffins and linear | | | | | | | | | | |
| alpha-olefins | | | | | | | | | | |
| more branched chain hydrocarbons in | | | | | | | | | | |
| the C-16 range | | | | | | | | | | |
| this sample has more olefin content | | | | | | | | | | |
| and dienes than the 100% LLDPE film | | | | | | | | | | |
| traces of naphthalene, methylnaphthalene, | | | | | | | | | | |
| biphenyl, methylbiphenyl & phenanthrene | | | | | | | | | | |
| traces of naphthenic hydrocarbons | | | | | | | | | | |
| such as alky-decalins | | | | | | | | | | |
| Total 10% ETOH Extractables | 6682.30 | 35.08 | 16583.7 | 73.80 | 1360.22 | 6.80 | 1387.40 | 6.59 | 4735.23 | 22.26 |

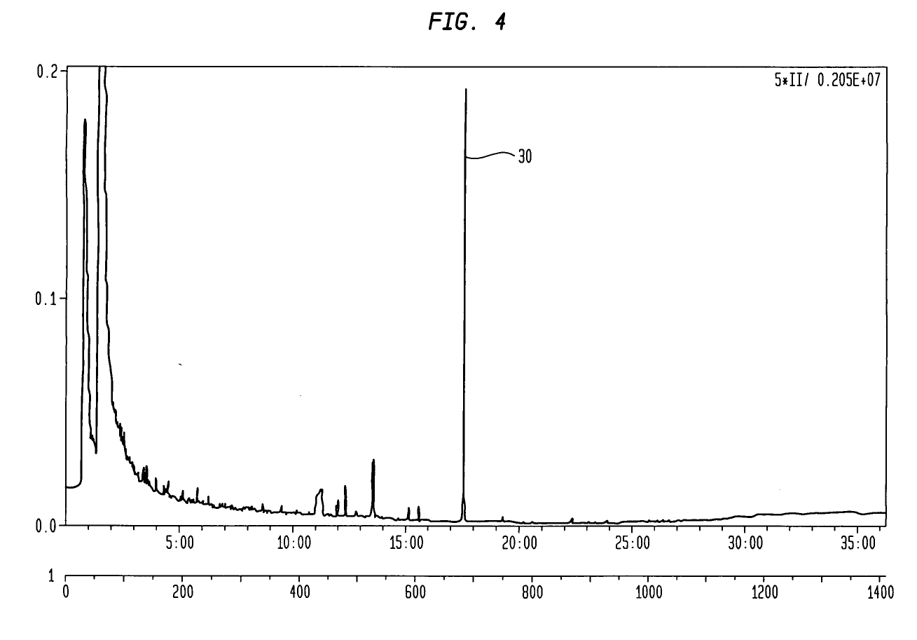

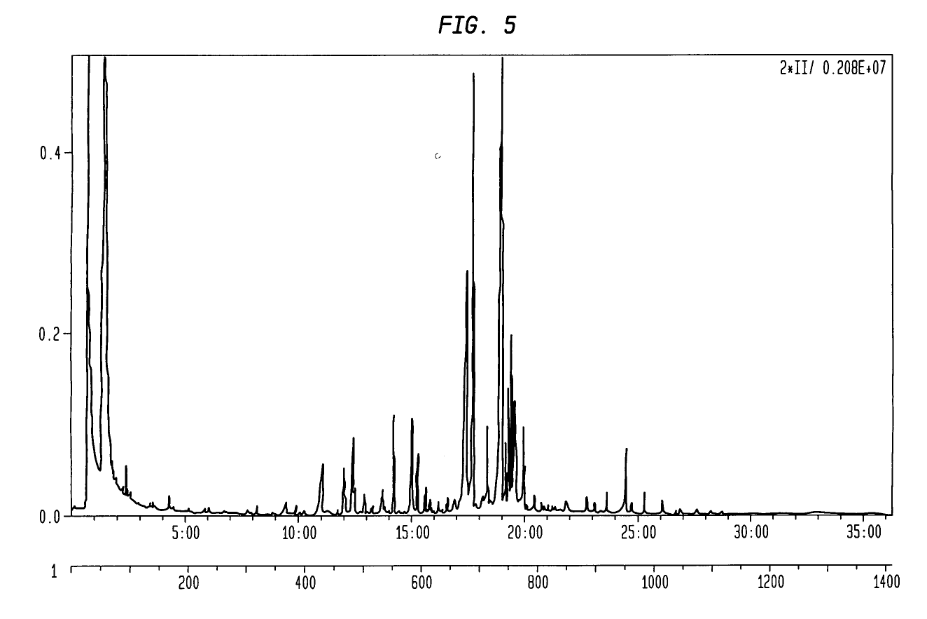

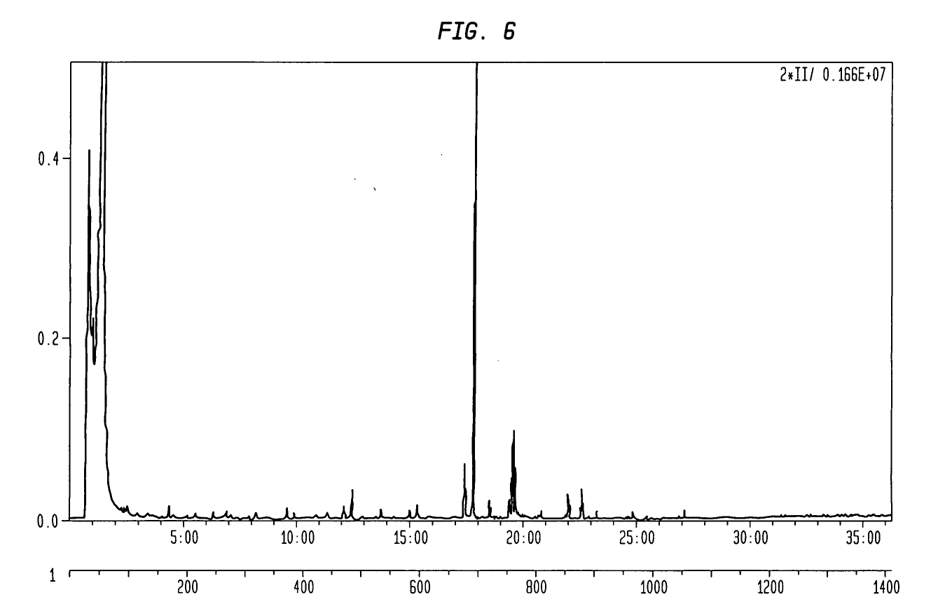

The results shown in Table 2 illustrate the comparative amount of “off-flavor” compounds that each film can expect to impart to a food or beverage product. As can be seen in Table 2, the total extractable content (in ng per cm² of layer surface area) was approximately 35 for Sample A, 74 for Sample B, 6.8 for Sample C, 6.6 for Sample D, and 22 for Sample E. The oligomer portion of these extractables (in ng/cm²) was approximately 6.6 for Sample A, 49 for Sample B, 3.8 for Sample C, 4 for Sample D, and 5.2 for Sample E. FIG. 3 shows the graphed results of Table 2 with the amount of extractable oligomers being demarked from the total extractables. FIGS. 4-6 also illustrate the comparable extractable content of LLDPE and COC. FIG. 4 is the GC-MS chromatogram of the method blank processed according to the extractable assay. Refering to FIG. 4, the large peak 20 which elutes at around 18:30 is anthracene-d₁₀ which was added as an internal standard. FIG. 5 is the GC-MS chromatogram of the extractables in Sample A (100% LLDPE). FIG. 6 is the GC-MS chromatogram of the extractables in Sample D (100% COC 1). As can be seen from the chromatograms, Sample A exhibits high extractable content in relation to Sample D.

The results indicate that the films made from 100% cycloolefin copolymer have remarkably lower extractables. The 100% COC films had approximately less than ⅕ the total extractables of the 100% LLDPE film, and less than a tenth of the total extractables of the film having 80% LLDPE. Similarly, the 100% COC layers had an oligomer extractable content of about 60% of the amount of the pure LLDPE film, and less than a tenth of the oligomer extractable content of the 80% LLDPE film. Interestingly, the film containing 80% COC and 20% LLDPE had much better values than the film with only 20% COC.

According to the results, layers having a high percentage of cycloolefin copolymer, especially layers consisting essentially of a cycloolefin copolymer can expect to maintain the flavor of the consumable better than layers with higher percentages of polyethylene, when such layers are in contact with the consumable. Also, remarkably, the film having 75% LLDPE and 25% COC had a higher extractable content than the 100% LLPE film. It is desirable, therefore, to have at least 75 wt. % of cycloolefin copolymer in the cycloolefin layer.

The flavor scalping properties of samples having the same composition as used in Examples 1 and 2, were tested by an assay which is described in detail in Example 3, below.

### EXAMPLE 3

### Flavor/Aroma Scalping Study of Polymer Samples

Orange Juice (Tropicana® pure premium, no pulp, not from concentrate) was used as the consumable for determining flavor scalping properties of the films. The flavor/aroma profile of the orange juice was previously analyzed using Purge and Trap-Thermal Desorption-GC-MS methodology. In this analysis, 10 ml of orange juice was diluted with 90 ml of distilled water, sealed in a glass purge vessel containing a magnetic stir bar and matrix-spiked with internal standards (100 ppb w/w, d-8 toluene and d-8 napthalene). Juice was heated to 50° C. for 30 minutes and purged with nitrogen at a flow rate of 40 ml/minute. Aroma/flavor volatiles were trapped and concentrated on a Tenax-TA adsorbent cartridge. The Tenax trap was then analyzed by Short Path Thermal Desorption-GC-MS. Compounds detected in the flavor/aroma profile of the orange juice were then targeted for investigation in the scalping study of the polymer samples. The targeted compounds are listed in Table 3.

The samples were selected to have a juice volume to polymer film surface area ratio was based on standard 200 ml size aseptic fill juice cartons. A carton was measured and the juice volume to polymer film surface area ratio was determined to be 0.83 ml/cm². Using this ratio, 60 cm² strips of film (6×10 cm) were cut and weighed into borosilicate glass test tubes sealed with Teflon-lined screw cap closures along with 50 ml of orange juice. Samples were secured to a rotary agitator set to low speed and then stored refrigerated for seven days. Each polymer sample was prepared in triplicate.

Following the seven day storage, the juice was emptied from each tube and the polymer samples were rinsed twice with distilled water. Films were removed from the tubes and blotted dry with lint-free towels. The film samples were then analyzed by Purge and Trap-Thermal Desorption-GC-MS methodology. In this analysis, the polymer films (60 cm²) were measured into a Scientific Instrument Service, Inc. (SIS, Ringoes N.J.) solid sample purge and trap apparatus. Samples were spiked with internal standards (1.0 μg of d-8 toluene and d-8 napthalene) and then heated to 100° C. for 30 minutes. During this time, the volatile out-gas products from the films were purged with nitrogen at a rate of 40 ml/min. The samples were trapped and concentrated on Tenax-TA adsorbent cartridges. Tenax traps were then analyzed by Short Path Thermal Desorption-GC-MS. The GC-MS conditions were the same as those used in Example 1.

The above-described protocol was proven sufficient to quantitatively isolate the scalped flavor compounds from the polymer samples. Desorbed polymers were rendered odorless by the purge and trap cycle and a second analysis of a spent polymer sample yielded a clean baseline indicating quantitative recovery. GC-MS chromatograms obtained from the exposed polymer samples were then subjected to a thorough scan-by-scan analysis and any orange juice-borne flavor/aroma compounds were identified and quantified. Polymer-borne out-gas products and any analysis artifacts were ignored. In the table, peak assignment of each flavor compound is identified as well as its concentration in ng/cm² and PPM w/w.

TABLE 3
Comparisons of Flavor Scalping of Samples

| | | | B | | C | | | | E | |
|---|---|---|---|---|---|---|---|---|---|---|
| | A | | 25% Topas + | | 100% Topas COC, | | D | | 80% Topas COC + | |
| | 100% LLDPE | | 75% LLDPE | | low Tg | | 100% Topas COC | | 20% LLDPE | |
| Table 3 | Conc. | Conc. | Conc. | Conc. | Conc. | Conc. | Conc. | Conc. | Conc. | Conc. |
| Peak Assignment | PPM | ng/cm2 | PPM | ng/cm2 | PPM | ng/cm2 | PPM | ng/cm2 | PPM | ng/cm2 |
| d-8 toluene (internal standard) | 3.13 | 16.67 | 3.62 | 16.67 | 3.30 | 16.67 | 3.30 | 16.67 | 3.41 | 16.67 |
| hexanal | 0.07 | 0.35 | 0.09 | 0.41 | 0.09 | 0.43 | 0.14 | 0.73 | 0.11 | 0.52 |
| ethyl butyrate | — | — | 0.19 | 0.89 | 0.60 | 3.04 | 0.11 | 0.55 | 0.10 | 0.51 |
| alpha-pinene | 1.02 | 5.46 | 0.90 | 4.15 | 2.09 | 10.59 | 1.14 | 5.73 | 1.08 | 5.28 |
| ? terp | 0.04 | 0.20 | 0.05 | 0.21 | 0.08 | 0.40 | 0.09 | 0.47 | 0.06 | 0.30 |
| benzaldehyde | 0.01 | 0.06 | 0.01 | 0.05 | 0.02 | 0.09 | 0.06 | 0.28 | 0.04 | 0.18 |
| beta-pinene | 0.30 | 1.61 | 0.17 | 0.80 | 0.32 | 1.62 | 0.32 | 1.62 | 0.26 | 1.25 |
| myrcene | 40.58 | 216.55 | 53.54 | 246.79 | 54.92 | 277.42 | 51.10 | 258.60 | 56.07 | 274.25 |
| octanal | 2.09 | 11.18 | 14.30 | 65.92 | 31.60 | 159.67 | 2.79 | 14.14 | 2.04 | 9.98 |
| limonene | 223.96 | 1195.08 | 251.24 | 1157.62 | 222.05 | 1122.15 | 219.48 | 1110.76 | 277.65 | 1357.59 |
| ocimene | 3.62 | 19.35 | 3.62 | 16.68 | 3.57 | 18.01 | 2.42 | 12.23 | 1.80 | 8.83 |
| gamma-terpinene | 8.34 | 44.44 | 9.58 | 44.17 | 10.39 | 52.49 | 11.13 | 56.35 | 11.20 | 54.74 |
| octyl alcohol | — | — | 0.35 | 1.63 | 0.49 | 2.48 | 0.18 | 0.89 | 0.08 | 0.42 |
| terpinolene | 3.72 | 19.92 | 6.17 | 28.42 | 4.56 | 23.05 | 4.43 | 22.41 | 4.29 | 20.97 |
| alpha-methylstyrene | 0.75 | 3.98 | 0.91 | 4.21 | 0.85 | 4.30 | 0.73 | 3.71 | 0.67 | 3.30 |
| linalool | 4.59 | 24.45 | 7.04 | 32.39 | 6.30 | 31.85 | 1.13 | 5.71 | 8.01 | 39.14 |
| nonanal | 3.47 | 18.70 | 5.43 | 25.08 | 5.92 | 29.91 | 1.18 | 5.96 | 8.12 | 39.72 |
| geraniol | 0.31 | 1.66 | 0.67 | 3.08 | 1.00 | 5.04 | 0.43 | 2.18 | 0.35 | 1.69 |
| linalool oxide I | 0.07 | 0.37 | 0.20 | 0.90 | 0.37 | 1.89 | 0.07 | 0.35 | 0.04 | 0.18 |
| linalool oxide II | 0.02 | 0.08 | 0.06 | 0.30 | 0.37 | 1.86 | 0.05 | 0.27 | 0.08 | 0.40 |
| camphor | 0.11 | 0.58 | 0.23 | 1.05 | 0.32 | 1.63 | 0.03 | 0.16 | 0.05 | 0.25 |
| d-8 naphthalene (internal standard) | 3.14 | 16.71 | 3.57 | 16.43 | 3.28 | 16.56 | 3.19 | 16.13 | 3.39 | 16.56 |
| alpha-terpineol | 1.79 | 9.56 | 1.65 | 7.66 | 1.87 | 9.46 | 0.24 | 1.20 | 0.10 | 0.50 |
| ethyl octanoate | — | — | 1.43 | 6.64 | 1.53 | 7.73 | 0.24 | 1.19 | 0.12 | 0.57 |
| decanal | 13.47 | 71.87 | 14.84 | 68.31 | 18.10 | 91.45 | 2.55 | 12.90 | 2.78 | 13.58 |
| ? terpenoid compd. | — | — | 0.41 | 1.87 | 0.68 | 3.45 | 0.10 | 0.50 | 0.05 | 0.22 |
| thymol, methyl ether | 0.31 | 1.66 | 0.44 | 2.02 | 0.50 | 2.51 | 0.11 | 0.55 | 0.07 | 0.33 |
| carvone | 0.48 | 2.55 | 1.12 | 5.15 | 1.70 | 8.59 | 0.48 | 2.42 | 0.31 | 1.52 |
| octyl acetate | 0.03 | 0.14 | 0.26 | 1.21 | 0.10 | 0.52 | 0.04 | 0.19 | 0.01 | 0.04 |
| perillal | 1.24 | 6.64 | 1.57 | 7.23 | 1.44 | 7.28 | 0.26 | 1.33 | 0.13 | 0.65 |
| decyl alcohol | 0.50 | 2.65 | 0.64 | 2.96 | 0.19 | 0.98 | 0.04 | 0.20 | 0.02 | 0.09 |
| undecanal | 1.86 | 9.88 | 1.35 | 6.20 | 0.89 | 4.50 | 0.13 | 0.67 | 0.05 | 0.25 |
| neryl acetate | 0.22 | 1.14 | 0.26 | 1.21 | 0.25 | 1.25 | 0.02 | 0.12 | 0.01 | 0.04 |
| terpinyl acetate | 0.90 | 4.66 | 0.28 | 1.28 | 0.17 | 0.88 | 0.06 | 0.31 | 0.03 | 0.12 |
| geranyl acetate | 1.26 | 6.71 | 2.54 | 11.73 | 1.28 | 6.47 | 0.41 | 2.06 | 0.30 | 1.47 |
| ylangene | — | — | 0.87 | 3.98 | 0.53 | 2.67 | 0.08 | 0.42 | 0.04 | 0.20 |
| alpha-copaene | 2.98 | 15.79 | 2.42 | 11.11 | 1.62 | 8.20 | 1.00 | 5.06 | 0.86 | 4.19 |
| elemene | 5.54 | 29.47 | 4.14 | 19.00 | 1.21 | 6.12 | 0.70 | 3.54 | 0.73 | 3.56 |
| undecyl alcohol | 3.62 | 19.24 | 2.89 | 13.21 | 0.21 | 1.04 | 0.08 | 0.40 | 0.07 | 0.36 |
| dodecanal | 7.59 | 40.28 | 5.69 | 26.13 | 2.46 | 12.45 | 0.31 | 1.57 | 0.36 | 1.76 |
| caryophyllene | 3.35 | 17.80 | 2.56 | 11.75 | 1.42 | 7.18 | 1.04 | 5.22 | 0.85 | 4.14 |
| gamma-cadiene | 2.71 | 14.38 | 2.06 | 9.44 | 1.29 | 6.51 | 0.91 | 4.57 | 0.79 | 3.84 |
| humulene | — | — | 0.57 | 2.65 | 0.17 | 0.84 | 0.91 | 4.58 | 0.73 | 3.59 |
| dodecanol | 2.91 | 15.69 | 1.06 | 4.90 | 1.30 | 6.55 | 0.23 | 1.16 | 0.18 | 0.88 |
| beta-selenene | 1.35 | 7.24 | 1.17 | 5.38 | 0.72 | 3.65 | 0.90 | 4.51 | 0.70 | 3.40 |
| gamma-selenene | 1.46 | 7.78 | 1.53 | 7.05 | 2.49 | 12.59 | 2.11 | 10.66 | 1.92 | 9.37 |
| valencene | 26.45 | 141.08 | 22.39 | 103.19 | 21.72 | 109.72 | 21.87 | 110.63 | 22.87 | 111.85 |
| beta-cadinene + murolene | 2.97 | 15.84 | 2.93 | 13.48 | 2.89 | 14.60 | 3.49 | 17.64 | 2.79 | 13.62 |
| cadinol | 0.37 | 1.97 | 0.20 | 0.91 | 0.10 | 0.49 | 0.02 | 0.12 | 0.03 | 0.15 |
| selenol | — | — | 0.26 | 1.21 | 0.09 | 0.46 | 0.01 | 0.05 | 0.01 | 0.07 |
| humulene oxide | — | — | 0.34 | 1.56 | 0.13 | 0.66 | 0.01 | 0.04 | 0.03 | 0.12 |
| Total Scalped Juice Flavor | 376.42 | 2008.05 | 432.61 | 1993.14 | 412.96 | 2086.71 | 335.36 | 1696.92 | 409.02 | 1999.97 |

As seen in Table 3, Sample D exhibited approximately 15% less flavor scalping than the other samples. Surprisingly, Sample D, which is 100% cycloolefin copolymer, absorbed approximately 19% less flavor than Sample C, which is also 100% cycloolefin copolymer. Without intending to be bound by theory it is thought that the higher glass transition temperature, as is found in the copolymer used in Sample D, acts as barrier layer preventing the absorbtion of consumable flavor compounds.

Therefore, to reduce flavor scalping, it is desirable to use cyclic olefin copolymers with high glass transition temperatures. And, preferably, the cycloolefin layer should comprise a large amount of cycloolefin copolymer because even blends with as much as 80% cycloolefin copolymer, did not have significantly reduced flavor scalping.

While the invention has been fully described in the context of particular embodiments, modifications to such specific embodiments within the spirit and scope of the present invention will be readily apparent to those of skill in the art.

What is claimed is:

1. A method of packaging a consumable product comprising:
(a) preparing a multilayer container having an interior wall with a food contact layer disposed thereon with a thickness of from about 0.5 to about 50 microns, wherein said food contact layer comprises at least about 75% by weight of a cycloolefin copolymer, and wherein the cycloolefin food contact layer is characterized by a total extractable concentration of less than about 30 ng per cm² of surface area when incubated in a 40 ml solution of 10% ethanol in distilled water for 24 hours at 60° C. with constant agitation; and
(b) disposing a consumable product in the container in contact with the food contact layer.

2. The method according to claim 1, wherein the food contact layer is adhered to a polyolefin layer selected from polyethylene layers and polypropylene layers.

3. The method according to claim 1, wherein said cycloolefin copolymer incorporates the residue of (i) the polycyclic structure of formula I, II, III, IV, V or VI, or (ii) the monocyclic structure of the formula VII: 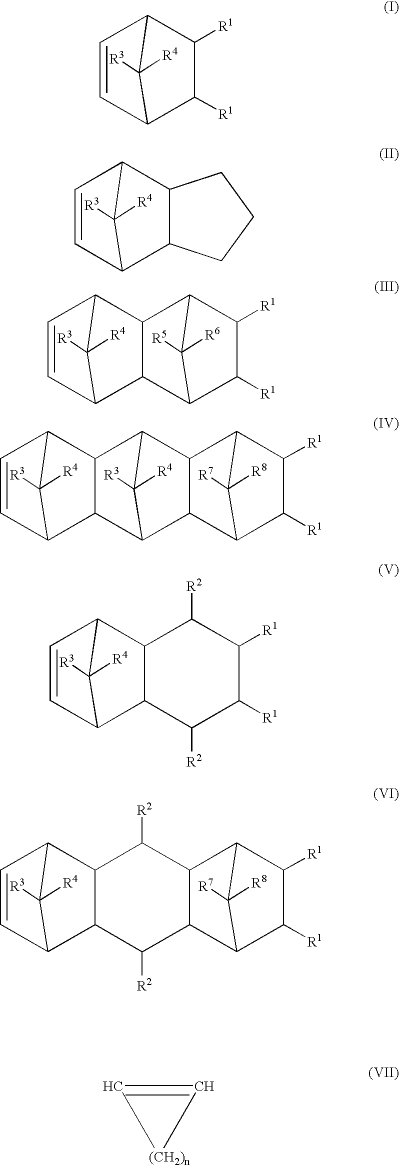
wherein R¹, R²,R³,R⁴, R⁵, R⁶, R⁷ and R⁸ are the same or different and are H, a C₆-C₂₀-aryl or C₁-C₂₀-alkyl radical or a halogen atom, and n is a number from 2to 10.

4. The method according to claim 1, wherein said cycloolefin copolymer incorporates the residue of norbornene.

5. The method according to claim 1, wherein said cycloolefin copolymer includes the residue of ethylene or propylene.

6. The method according to claim 1, wherein said cycloolefin copolymer consists essentially of the residues of norbonene and ethylene.

7. The method according to claim 6, wherein said cycloolefin copolymer has a norbornene content of between about 20-50 mol %.

8. The method according to claim 7, wherein said cycloolefin copolymer has a norbornene content of between about 30-40 mol %.

9. The method according to claim 1, wherein said cycloolefin copolymer has a glass transition temperature of at least about 70° C.

10. The method according to claim 1, wherein the cycloolefin food contact layer consists essentially of a cycloolefin copolymer.

11. The method according to claim 1, wherein the cycloolefin food contact layer has a thickness of about 1 to about 10 microns.

12. The method according to claim 1, wherein the cycloolefin food contact layer has a thickness of about 2 to about 7 microns.

13. The method according to claim 2, wherein said polyolefin layer comprises polyethylene.

14. The method according to claim 13, wherein said polyethylene comprises LDPE.

15. The method according to claim 13, wherein said polyethylene comprises LLDPE.

16. The method according to of claim 2, wherein said polyolefin layer comprises polypropylene.

17. The method according to claim 1, wherein said cycloolefin food contact layer is further characterized as having a volatile out-gas profile of less than about 30 ng of total volatiles per cm² of surface area, when heated to a temperature 80° C. for 30 minutes in a solid sample purge and trap apparatus.

18. The method according to claim 17, wherein said cycloolefin food contact layer is further characterized as having a volatile out-gas profile of less than about 20 ng of total volatiles per cm² of surface area, when heated to a temperature 80° C. for 30 minutes in a solid sample purge and trap apparatus.

19. The method according to claim 1, wherein said cycloolefin food contact layer is further characterized as having a volatile out-gas profile of less than about 5 ng of oligomers per cm² of surface area, when heated to a temperature 80° C. for 30 minutes in a solid sample purge and trap apparatus.

20. The method according to claim 1, wherein the cycloolefin food contact layer is further characterized as having a total extractable concentration of less than about 10 ng per cm² of surface area when incubated in a 40 ml solution of 10% ethanol in distilled water for 24 hours at 60° C. with constant agitation.

21. The method according to claim 1, wherein the cycloolefin food contact layer is further characterized as having an oligomer extractable concentration of less than about 6 ng per cm² of surface area when incubated in a 40 ml solution of 10% ethanol in distilled water for 24 hours at 60° C. with constant agitation.

22. The method according to claim 2, where said container reduces the transport of flavor compounds from said consumable product to said polyolefin layer, wherein said food contact layer consists essentially of a cycloolefin copolymer and said cycloolefin copolymer has a glass transition temperature of at least 70° C.

23. A container for receiving a consumable comprising:
(a) a structural member of one or more layers defining a shape for the container including an interior wall of the container; and
(b) a food contact layer adhered to the interior of the structural member being of a thickness of from about 0.5 to about 50 microns, wherein said food contact layer comprises at least about 75% by weight of a cycloolefin copolymer, and wherein the cycloolefin food contact layer is characterized by a total extractable concentration of less than about 30 ng per cm² of surface area when incubated in a 40 ml solution of 10% ethanol in distilled water for 24 hours at 60° C. with constant agitation.

24. The container according to claim 23 wherein said container is a blow-molded container.

25. The container according to claim 23, wherein said container is a thermoformed container.

26. The container according to claim 23, wherein said container is selected from the group consisting of a bag, a pouch, a bottle, and a paperboard container.

27. A flavor-preserving film for packaging a consumable product comprising:
(a) at least one layer which comprises a polyolefin selected from the group consisting of polyethylene and polypropylene; and
(b) at least one food contact layer having a thickness of between about 0.5 and 50 microns, said food contact layer comprising at least about 75 wt. % of a cycloolefin copolymer, wherein the cycloolefin copolymer has a glass transition temperature of at least about 70° C., and wherein the cycloolefin food contact layer is characterized by a total extractable concentration of less than about 30 ng per cm² of surface area when incubated in a 40 ml solution of 10% ethanol in distilled water for 24 hours at 60° C. with constant agitation.

28. The flavor-preserving film of claim 27, wherein the cycloolefin copolymer has a glass transition temperature of at least about 75° C.

29. The flavor-preserving film of claim 27, wherein the food contact layer consists essentially of a cycloolefin copolymer.

30. The flavor-preserving film of claim 27, wherein the cycloolefin copolymer consists essentially of the residues of norbornene and ethylene.

31. The flavor preserving film of claim 27, wherein the polyolefin layer comprises polyethylene.

32. The flavor preserving film of claim 27, wherein the polyolefin layer comprises a polyolefin selected from the group consisting of LDPE and LLDPE.
